(19) United States
(12) Patent Application Publication
(10) Pub. No.: US 2025/0292009 A1
(43) Pub. Date: Sep. 18, 2025

(54) Report Design Wizard

(71) Applicant: Solver, Inc., Calabasas, CA (US)

(72) Inventors: Andrew Bolseth, Oslo (NO); Michael Applegate, Porter Ranch, CA (US); Nils Rasmussen, Miami Beach, FL (US)

(21) Appl. No.: 18/602,693

(22) Filed: Mar. 12, 2024

(51) Int. Cl. G06F 40/186; G06F 3/0486; G06F 40/103

(52) U.S. Cl. CPC G06F 40/186; G06F 3/0486; G06F 40/103

(57) ABSTRACT

A method of generating a user-formatted report comprises providing a first graphical user interface by which a user may define one or more ranges of measures respectively for one or more attributes of user account data, query a database to retrieve user account data falling within the one or more ranges of measures, define columns and rows of data based on the retrieved user account data, and view the columns and rows of data as a table. The method may further comprise, in response to a request received over the graphical user interface, converting the table to a file having an extensible markup language (XML) format that defines one or more dynamic groups of rows or columns corresponding respectively to the one or more ranges of measures.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Creating professionally formatted reports with financial and operational data in financial report writing software can be quite technical and typically requires highly trained power users. Therefore, many companies either rely heavily on external consultants or they invest in an internal team. The latter can be an issue when a company experiences high employee turnover because they can lose their experts and therefore lack the know-how to build new reports for their management teams.

The main reason it takes advanced skills and significant effort to design professionally formatted operational and financial reports in any business report writing software is that there are many steps involved, such as applying user security so each individual only can see the data they are entitled to see, knowing where in the database to find the dimensions and data, moving the dimension fields (e.g., Entity, Account, Sales Person, Vendor, Customer, etc.) and data fields (e.g., Transaction Date, Calendar Period, Amount, etc.) into the report in the right places, applying filters to only see certain information in the report, applying professional formatting such as double underlines, colors, fonts, and charts, and saving the report for use by end users. Because of the user knowledge required to build professionally formatted, advanced reports, most companies end up with at least two reporting software solutions: one for easy, ad-hoc reporting and one for advanced, professional-looking reports. Unfortunately, this approach is inefficient as it may often be the case that these two unconnected software applications are used to access and present the same underlying data within approximately the same timeframe, for example, in a case where an ad-hoc report is generated in the short term and a professionally formatted report is thereafter made based on the ad-hoc report.

### BRIEF SUMMARY

The present disclosure contemplates various systems and methods for overcoming the above drawbacks associated with the related art. One aspect of the embodiments of the present disclosure is a computer program product comprising one or more non-transitory program storage media on which are stored instructions executable by one or more processors or programmable circuits to perform operations for generating a user-formatted report. The operations may comprise providing a first graphical user interface by which a user may define one or more ranges of measures respectively for one or more attributes of user account data, query a database to retrieve user account data falling within the one or more ranges of measures, define columns and rows of data based on the retrieved user account data, and view the columns and rows of data as a table. The operations may further comprise, in response to a request received over the graphical user interface, converting the table to a file having an extensible markup language (XML) format that defines one or more dynamic groups of rows or columns corresponding respectively to the one or more ranges of measures.

The operations may further comprise providing a second graphical user interface by which a user may customize a spreadsheet generated from the file. The customizing of the spreadsheet may include customizing a report template that is produced from the file, with the spreadsheet to be generated using the report template. The one or more dynamic groups may be embedded in the report template. Each of the one or more dynamic groups embedded in the report template may be expandable over the respective attribute.

The first graphical user interface may allow the user to define one or more filters for further limiting the user account data retrieved from the database. The file having the XML format may define a filter for each of the one or more filters defined by the user. The one or more filters may include a filter that applies to a designated one of the columns and rows of data and/or a filter that applies globally to the retrieved user account data.

Another aspect of the embodiments of the present disclosure is a method of generating a user-formatted report. The method may comprise providing a first graphical user interface by which a user may define one or more ranges of measures respectively for one or more attributes of user account data, query a database to retrieve user account data falling within the one or more ranges of measures, define columns and rows of data based on the retrieved user account data, and view the columns and rows of data as a table. The method may further comprise, in response to a request received over the graphical user interface, converting the table to a file having an extensible markup language (XML) format that defines one or more dynamic groups of rows or columns corresponding respectively to the one or more ranges of measures.

Another aspect of the embodiments of the present disclosure is a system for generating a user-formatted report. The system may comprise an electronic device having a display screen for displaying a graphical user interface by which a user may define one or more ranges of measures respectively for one or more attributes of user account data, query a database to retrieve user account data falling within the one or more ranges of measures, define columns and rows of data based on the retrieved user account data, and view the columns and rows of data as a table. The system may further comprise an XML converter operable, in response to a request received over the graphical user interface, to convert the table to a file having an extensible markup language (XML) format that defines one or more dynamic groups of rows or columns corresponding respectively to the one or more ranges of measures.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an example system for generating a user-formatted report according to an embodiment of the present disclosure;

FIG. 2 is an example view of an ad-hoc reporting graphical user interface (GUI) that may be accessible by an electronic device of the system;

FIG. 3 is another example view of the ad-hoc reporting GUI;

FIG. 4 is an example view of a report designer GUI that may be accessible by the electronic device;

FIG. 5A is another example view of the report designer GUI;

FIG. 5B is another example view of the report designer GUI;

FIG. 6 is another example view of the report designer GUI;

FIG. 7 is another example view of the report designer GUI;

FIG. 8 is another example view of the report designer GUI;

FIG. 9 is another example view of the report designer GUI; and

FIG. 10 is an example screenshot showing a report generated by the system.

### DETAILED DESCRIPTION

The present disclosure encompasses various embodiments of systems and methods for generating a user-formatted report, including but not limited to those described in relation to an exemplary cloud-based financial software solution described herein. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

The exemplary cloud-based financial software solution that may embody one or more of the disclosed embodiments may be regarded as belonging to a software category most often referred to as Corporate Performance Management (CPM) software. CPM solutions integrate with Enterprise Resource Planning (ERP) systems to import financial dimensions such as company, general ledger (GL) accounts, etc. and financial data such as revenues, expenses, assets, liabilities, and equity. CPM solutions store this information in their database (which may be referred to as a “data warehouse”). A trained consultant or customer may then use these dimensions and data to deliver:
1) Financial reports such as different variations of Trial Balances, Profit & Loss reports, and Balance Sheets;
2) Planning models with web-based input forms to capture budget and forecast data and with workflow for approvals, rejections, etc.; and
3) Dashboards that provide managers with graphical analysis of their data.

As described herein, such systems may deliver advanced financial reporting and budgeting functionality to accounting and finance departments and, in this regard, may offer several key components, including:
1) Report Designer: This may be an Excel add-in where trained power users create fully formatted financial reports (profit & loss reports, balance sheets, etc.), operational reports (sales reports, payables reports, receivables reports, etc.) as well as budget and forecast input forms. The user may design reports using database fields from the data warehouse combined with standard Excel formatting and calculation features.
2) Ad Hoc Reporting: This is a module where end users with minimal training can design reports on the fly. These reports have rows and columns as well as sub-totals and totals, but advanced formatting such as fonts, colors, etc. may be unsupported.
3) Web Portal: Here, end users may run reports and enter budgets, and administrators may manage the data warehouse, security, etc.
4) Data Warehouse: This is where data uploaded from ERP systems as well as directly entered budget data may be stored.

In summary, companies and organizations use CPM software to automate and simplify their financial reporting, budgeting, and forecasting processes. The ability to easily build and maintain reports is a critical component enabling customers to configure and maintain the CPM solution to provide decisionmakers with accurate and professionally formatted reports. The target users exist in all industries and they are typically CFOs, controllers, and budget managers in a business's office of finance, as well as executives and department managers.

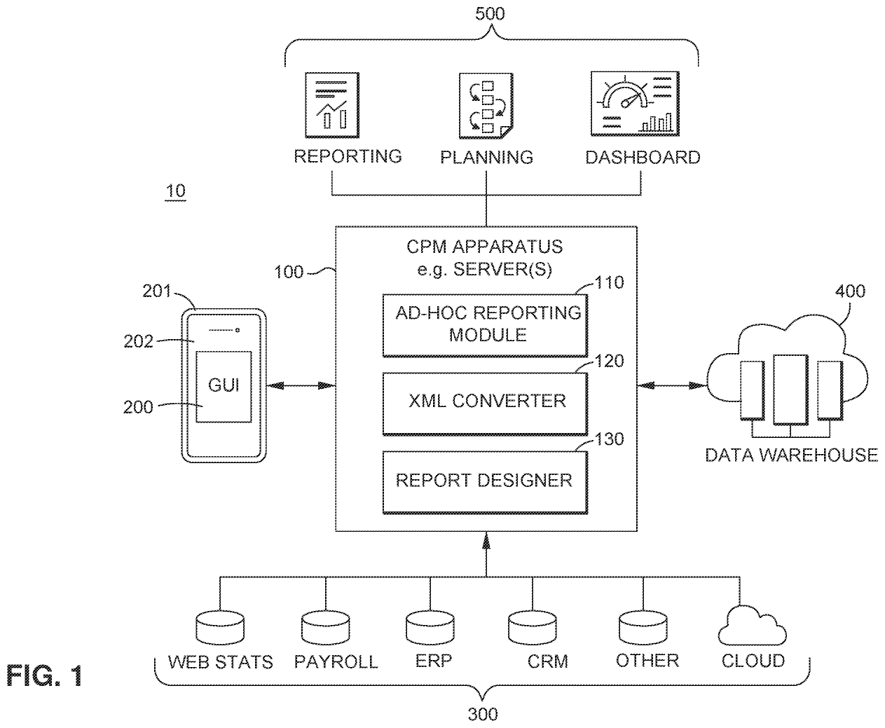

FIG. 1 shows an example system 10 for generating a user-formatted report according to an embodiment of the present disclosure. The system 10 may embody one or more aspects of the envisioned cloud-based financial software solution described herein, in particular as pertains to importing user account data and generating one or more financial or operational reports as described above. In this regard, the system 10 may include a CPM apparatus 100 that may be a server or a combination of networked servers that communicate with a user of the system 10 over a graphical user interface (GUI) 200 accessible via a web browser or mobile application of an electronic device 201 (e.g., a user's smartphone, tablet, or personal computer), as well as communicating with various data sources 300 (e.g., ERP systems, web stats, payroll, CRM, or other systems, including cloud-based systems) and with a data warehouse 400 (e.g., one or more databases). The system 10 and CPM apparatus 100 thereof may include any or all of the features described in U.S. Pat. No. 11,657,218, entitled “CUSTOM TEMPLATE GENERATION USING UNIVERSAL CODE,” the entire disclosure of which is incorporated by reference herein. Unlike conventional CPM software, the disclosed CPM apparatus 100 may provide functionality to convert tables produced using ad-hoc reporting software into a format that is usable to produce professionally formatted reports. Owing to such functionality, the system 10 may advantageously bridge the user knowledge gap between designing simple, unformatted reports and advanced, professionally formatted reports.

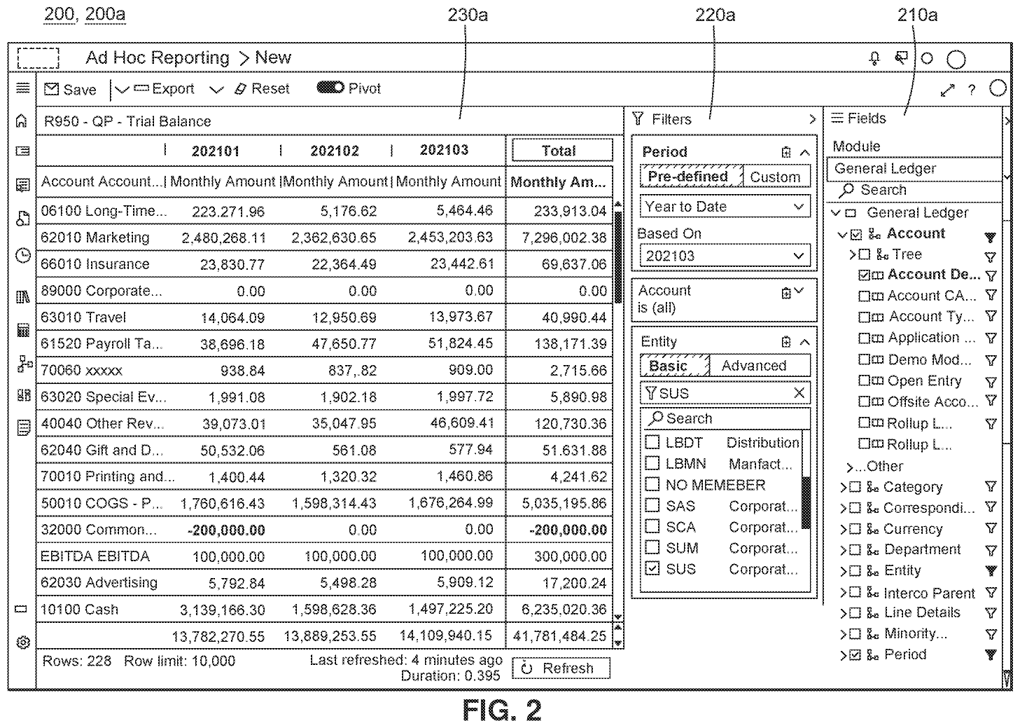

Referring to FIGS. 1 and 2, an ad-hoc reporting module 110 of the CPM apparatus 100 may provide an ad-hoc reporting GUI 200a, which may be a component of the GUI 200 accessible via the electronic device 201 shown in FIG. 1. The ad-hoc reporting GUI 200a may support simple drag-and-drop reports for creating reports on the fly. An example of the ad-hoc reporting GUI 200a is shown in FIG. 2, whereby a user may define one or more ranges of measures (e.g., numbers/amounts that can be aggregated) respectively for one or more attributes of user account data, as may be selectable in a fields pane 210a, for example. A user might define a range of account numbers, for example. The user may further define one or more filters for further limiting the user account data to be retrieved. In this regard, the GUI 200a may include a filters pane 220a with functionality to filter the data by date or other attributes, for example. Using the GUI 200a, the user may then query one or more databases of the data warehouse 400 to retrieve user account data falling within the one or more ranges of measures as filtered by the user. Based on the retrieved user account data, a table 230a may be displayed on the ad-hoc reporting GUI 200a having columns and rows of data as may be defined by the user, with the filters applying either to a designated column or row or globally to the retrieved user account data as desired.

In response to a request received over the GUI 200, an XML converter 120 of the CPM apparatus 100 may then convert the table to a file having an extensible markup language (XML) format. The XML format may be used by a variety of report design software solutions such as a spreadsheet-based report designer that may be built as a Microsoft Excel add-in, for example. The request to convert the table to XML format may be made within the ad-hoc reporting GUI 200a using an “Export” drop-down menu (see FIG. 2), for example. Advantageously, for each of the one or more ranges of measures defined using the ad-hoc reporting GUI 200a (e.g., a range of months from January to March or a range of General Ledger accounts from 1000 to 9999), the XML file may define a dynamic group of rows or columns. The definition of a dynamic group in the XML file may include, for example, a designation of a group type (e.g., row or column), row/column number, size, and whether the group should be expandable/collapsible. In general, the XML file may define all structural and layout information required to query and transform a dataset (e.g., a SQL dataset) into a structured report, but without containing formatting information like colors or fonts. The XML file may contain sections for parameters, groups/filters, and attributes/measures. The elements of the XML file may also contain positional information like row, column, cell location, etc., making it possible to expand the appropriate rows/columns and to position the data in appropriate cells. The XML file may function as an instruction set to tell a report engine (e.g., the report designer 130 described in more detail below) what data to fetch, how to group and filter that data, and how to build the report matrix and position the data. Parameters of the XML file may serve as placeholders that instruct the UI to prompt the user for an input, e.g., what entity they want to run the report for, with those values then being inserted into the filters when the report is run.

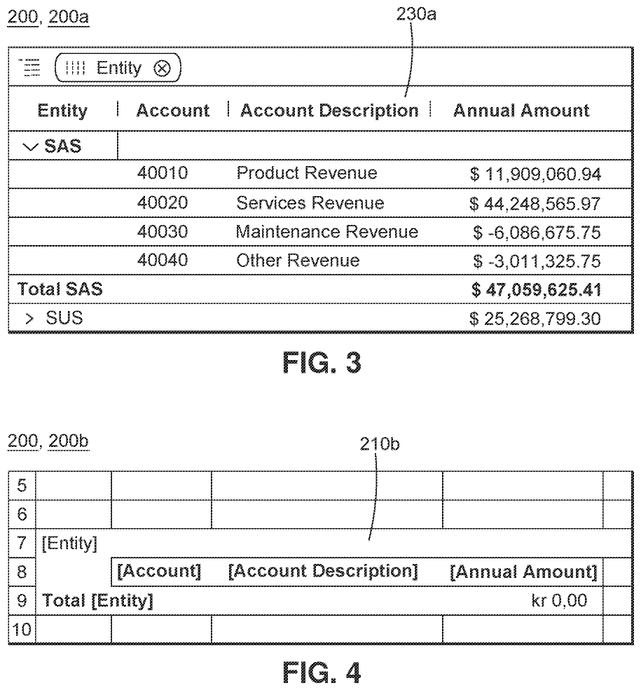

An example of the disclosed conversion is illustrated in FIGS. 3 and 4. In FIG. 3, an example table 230a is shown, which may be generated using the ad-hoc reporting GUI 200a as described above. FIG. 4 is an example view of a report designer GUI 200b, which may be a further component of the GUI 200 accessible via the electronic device 201 shown in FIG. 1. In contrast to the ad-hoc reporting GUI 200a, the report designer GUI 200b may support advanced, professionally formatted reports (both types of reports being illustrated as “Reporting” in FIG. 1). The report designer GUI 200b may be provided by a report designer 130 of the CPM apparatus 100 and may allow a user to customize a spreadsheet generated from an XML file. As shown in FIG. 3, the table 230a produced using the ad-hoc reporting GUI 200a may display SAS and SUS data (e.g., “SAS” and “SUS being example codes for an entity dimension) for a range of accounts 40010-42000, resulting in rows of each of four accounts, numbered 40010, 40020, 40030, and 40040. In FIG. 4, a report template 210b is shown that is produced using the report designer GUI 200b based on the example table 230a of FIG. 3. The report template 210b, which may be used to generate and customize a spreadsheet using the report designer GUI 200b, may be produced from the XML file so as to have one or more dynamic groups of rows or columns corresponding to the ranges of measures populating the table 230a. Thus, in the illustrated example, the rows of the report template 210b corresponding to the “Entity” and “Account” attributes may dynamically expand to encompass the ranges of measures that were defined using the ad-hoc reporting GUI 200a, allowing a seamless transition from populating the table 230a with data from the data warehouse 400 to customizing the design and layout of a spreadsheet generated from a corresponding report template 210b.

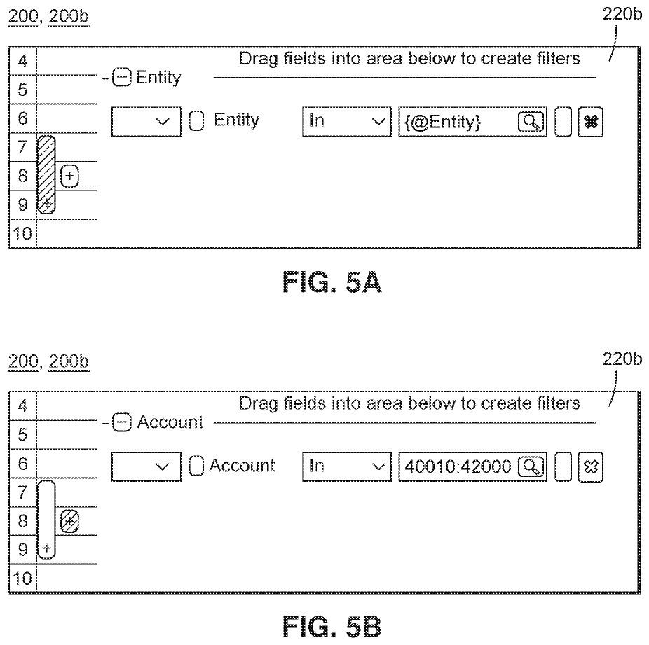

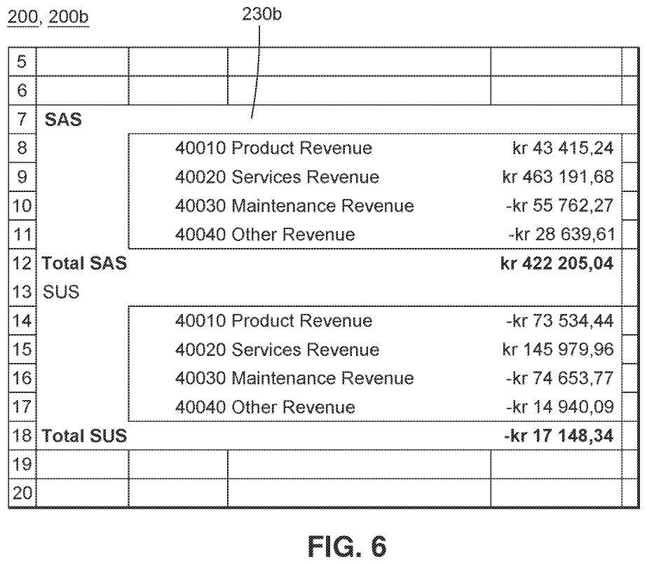

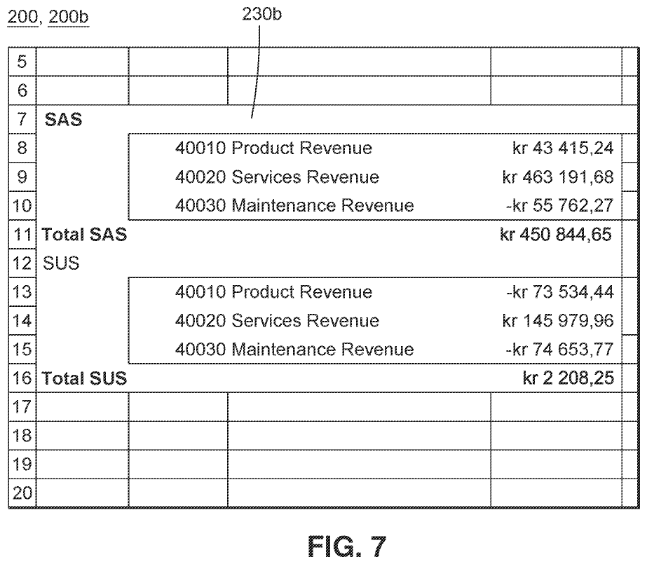

FIGS. 5A and 5B show a layout editor 220b of the report designer GUI 200b. As can be seen, two dynamic groups have been generated. In FIG. 5A, a first dynamic group is selected corresponding to rows 7-9 (see FIG. 4), which expands over the “Entity” attribute (e.g., SAS or SUS in the example). In FIG. 5B, a second dynamic group is selected corresponding to row 8, which expands over the “Account” attribute (e.g., 40010:42000). The ranges may be defined by the XML file (e.g., as in the case of the range of accounts 40010:42000 which may be specified using the filters pane 220a of the ad-hoc reporting GUI 201a) or may be defined by a parameter “{@Entity}” to be input by a user in the report designer GUI 201b (e.g., as in the case of inputting one or more entities for which to run the report template 210b). Running this report template 210b using the report designer GUI 200b may result in a customizable spreadsheet 230b as shown in FIG. 6. Owing to the dynamic groups being embedded within the underlying report template 210b, as made possible by the novel XML conversion described herein, the spreadsheet 230b may automatically reflect any changes to the data in the data warehouse 400. Thus, if the “40040 Other Revenue” account were to be deleted from the data warehouse 400, running the same report template 210b would result in a corresponding change to the spreadsheet 230b as shown in FIG. 7. Namely, the dynamic group of rows expanding over the “Account” attribute (e.g., 40010:42000) would now only include rows for account numbers 40010, 40020, and 40030, as automatically reflected for both the SAS and SUS entities in the spreadsheet 230b. By the same token, if the user decided to add a new account (e.g., 40050) that is within the range in the report template 210b (e.g., 40010:42000), the account would automatically be included and would display as a new row in the spreadsheet 230b.

The dynamic groups of rows and columns may be flexibly customized and formatted as desired using the report designer GUI 200b, such that the relative positions, styles, etc. of the presentation of the data may be freely modified while the underlying data continues to reflect the actual data corresponding to the queries made using the ad-hoc reporting GUI 200a. In addition to applying any Excel functionality such as formulas and formatting (e.g., calculations, fonts, colors, and charts), for example, the user of the report designer GUI 200b may resize and reposition the groups, add more groups, modify filters, grouping, sorting, etc. The end result will be a professionally formatted report. When the user clicks “Save” in the report designer GUI 200b, the combination of the original XML code from the converted ad-hoc report and the new XML code from the Excel formatting may be saved together as a new XML file representing the report template 210b, which can subsequently be run to generate the spreadsheet 230b. Due to this unique “bridging” of what is normally two different technologies in CPM tools, namely easy ad-hoc reporting and advanced formatted reports, the disclosed technology that takes care of this transformation as described herein may dramatically reduce implementation time of such professionally formatted report templates from typically 1 day and down to as little as 5 minutes. Related to this major efficiency gain in implementation time are also additional benefits such as a reduced likelihood of poorly designed reports, fewer formula mistakes, and much less user skill required.

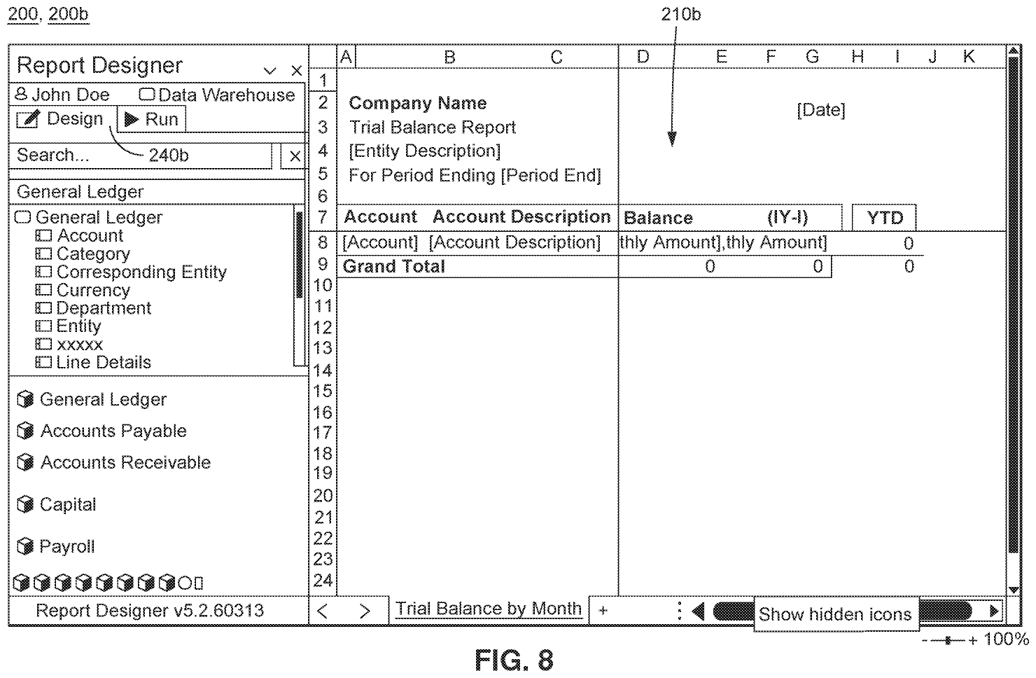

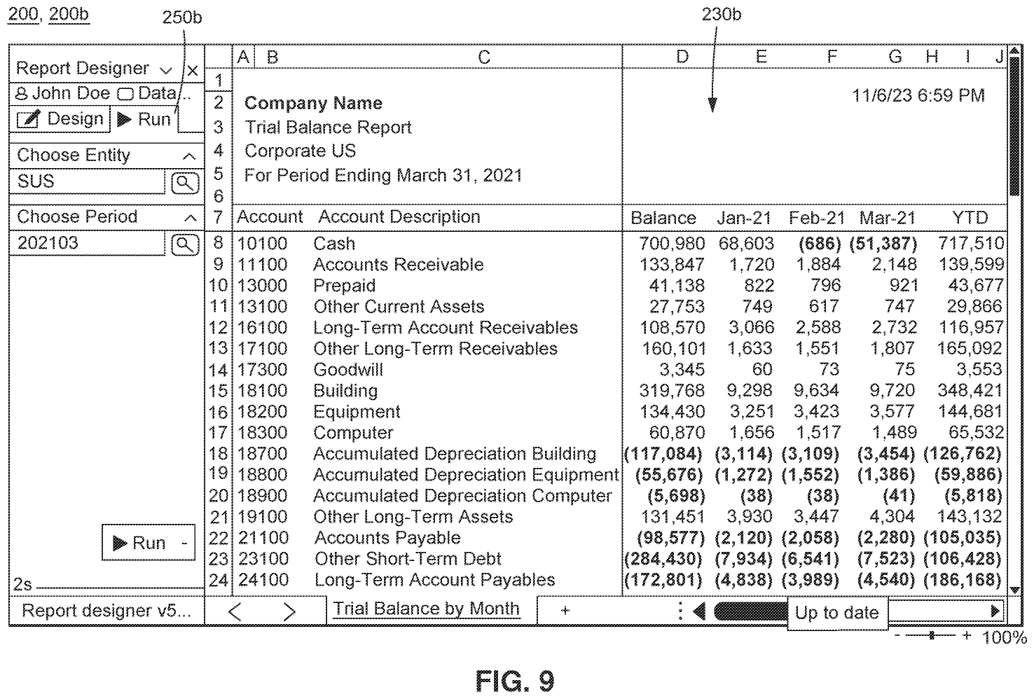

FIGS. 8 and 9 are further example views of the report designer GUI 200b showing additional user interface detail thereof. In FIG. 8, a “Design” tab 240b is selected, providing an interface for customizing a report template 210b as described above in relation to FIG. 4. In FIG. 9, a “Run” tab 250b is selected, providing an interface for running the report template 210b to generate a spreadsheet 230b as described above in relation to FIGS. 6 and 7. The report designer GUI 200b may be activated through the GUI 200 (e.g., web portal) when the user creates or modifies a report template 210b. The report designer GUI 200b may be a separate tool which is installed as a plugin to Excel and only activates when a report template file is opened. The layout editor window shown by way of example in FIG. 5 may also open by default and may represent the interface for defining dynamic groups and filters. It may be row/column/cell sensitive so that when you navigate the Excel spreadsheet by selecting rows/columns/cells it will update the information in the interface to show the underlying filters and group properties of the selected row/column/cell. The user may be able to define and format their report as they wish in the report designer GUI 200b and may also test the report by switching to the “Run” tab 250b, select parameters (filters), and clicking the “Run” button. The report template 210b will query the database and return the resulting data. When the user is happy with the report template 210b, it can save the Excel file which will then automatically upload into the cloud portal and the user can open and run the report through the web interface without needing to use the report designer GUI 200b or Excel.

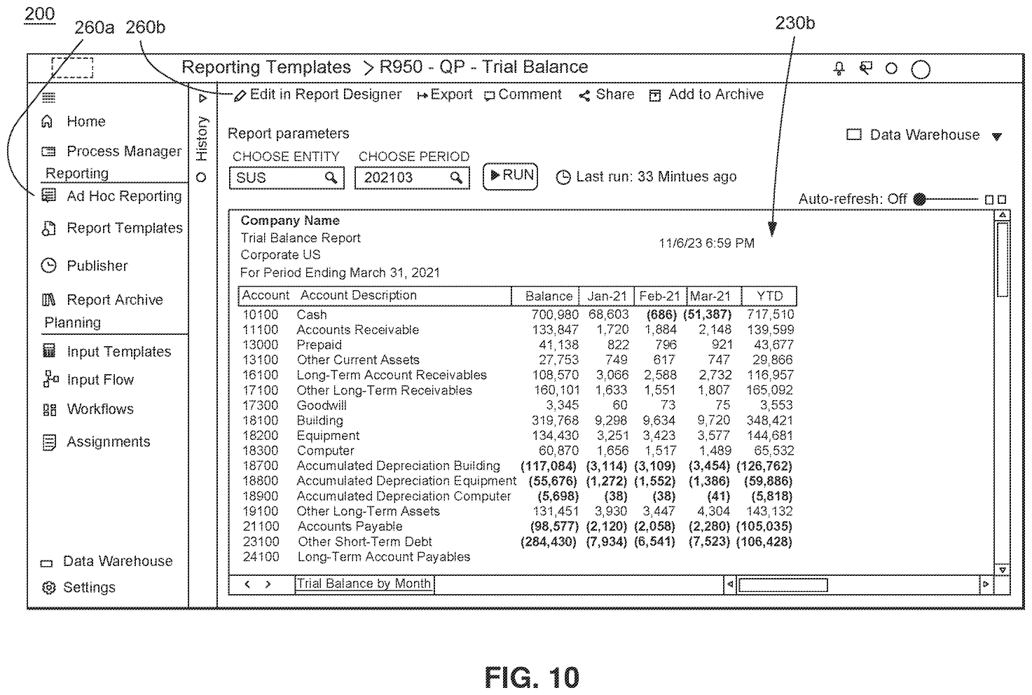

FIG. 10 is an example screenshot of the GUI 200 showing a report generated by the system, which may be the spreadsheet 230b generated using the report designer GUI 200b as described above. The user may enjoy professional, dynamic, fully formatted reports in a web browser with full user security. As illustrated, the GUI 200 may include navigation buttons 260a, 260b by which a user may access the ad-hoc reporting GUI 200a and report designer GUI 200b, respectively, as well as various other navigation buttons for accessing other components of the GUI 200 to utilize other features of the CPM apparatus 100 and system 10. The various GUIs 200a, 200b accessible via the GUI 200 may constitute a report design wizard having the features described herein.

The functionality described above in relation to the components of the system 10, including the CPM apparatus 100, ad-hoc reporting module 110, XML converter 120, report designer 130, and mobile app or website for presenting the GUI 200, 200a, 200b as shown in FIGS. 1-10, as well as the operational flows described throughout the disclosure, may be wholly or partly embodied in one or more computers including a processor (e.g. a CPU), a system memory (e.g. RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g. over the Internet), such as between the electronic device 201 and one or more servers embodying the CPM apparatus 100 or between one or more servers embodying the CPM apparatus 100 and one or more computers/databases embodying any of the data sources 300, the data warehouse 400, a template marketplace 500, etc. To the extent that functionality may be performed at a server (rather than by a mobile app installed on the electronic device 201, for example), any server contemplated herein may comprise multiple physical servers and other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A computer program product comprising one or more non-transitory program storage media on which are stored instructions executable by one or more processors or programmable circuits to perform operations for generating a user-formatted report, the operations comprising:
providing a first graphical user interface by which a user may define one or more ranges of measures respectively for one or more attributes of user account data, query a database to retrieve user account data falling within the one or more ranges of measures, define columns and rows of data based on the retrieved user account data, and view the columns and rows of data as a table; and,
in response to a request received over the graphical user interface, converting the table to a file having an extensible markup language (XML) format that defines one or more dynamic groups of rows or columns corresponding respectively to the one or more ranges of measures.

2. The computer program product of claim 1, wherein the operations further comprise providing a second graphical user interface by which a user may customize a spreadsheet generated from the file.

3. The computer program product of claim 2, wherein said customizing includes customizing a report template that is produced from the file, the spreadsheet being generated using the report template.

4. The computer program product of claim 3, wherein the one or more dynamic groups is embedded in the report template.

5. The computer program product of claim 4, wherein each of the one or more dynamic groups embedded in the report template is expandable over the respective attribute.

6. The computer program product of claim 1, wherein the operations further comprise providing a second graphical user interface by which a user may customize a report template that is produced from the file.

7. The computer program product of claim 6, wherein the one or more dynamic groups is embedded in the report template.

8. The computer program product of claim 7, wherein each of the one or more dynamic groups embedded in the report template is expandable over the respective attribute.

9. The computer program product of claim 1, wherein the first graphical user interface further allows the user to define one or more filters for further limiting the user account data retrieved from the database, and the file having the XML format further defines a filter for each of the one or more filters defined by the user.

10. The computer program product of claim 9, wherein the one or more filters includes a filter that applies to a designated one of the columns and rows of data.

11. The computer program product of claim 9, wherein the one or more filters includes a filter that applies globally to the retrieved user account data.

12. A method of generating a user-formatted report, the method comprising:
providing a first graphical user interface by which a user may define one or more ranges of measures respectively for one or more attributes of user account data, query a database to retrieve user account data falling within the one or more ranges of measures, define columns and rows of data based on the retrieved user account data, and view the columns and rows of data as a table; and,
in response to a request received over the graphical user interface, converting the table to a file having an extensible markup language (XML) format that defines one or more dynamic groups of rows or columns corresponding respectively to the one or more ranges of measures.

13. The method of claim 12, further comprising providing a second graphical user interface by which a user may customize a spreadsheet generated from the file.

14. The method of claim 13, wherein said customizing includes customizing a report template that is produced from the file, the spreadsheet being generated using the report template.

15. The method of claim 14, wherein the one or more dynamic groups is embedded in the report template.

16. The method of claim 15, wherein each of the one or more dynamic groups embedded in the report template is expandable over the respective attribute.

17. The method of claim 12, further comprising providing a second graphical user interface by which a user may customize a report template that is produced from the file.

18. The method of claim 17, wherein the one or more dynamic groups is embedded in the report template.

19. The method of claim 18, wherein each of the one or more dynamic groups embedded in the report template is expandable over the respective attribute.

20. A system for generating a user-formatted report, the system comprising:
an electronic device having a display screen for displaying a graphical user interface by which a user may define one or more ranges of measures respectively for one or more attributes of user account data, query a database to retrieve user account data falling within the one or more ranges of measures, define columns and rows of data based on the retrieved user account data, and view the columns and rows of data as a table; and
an XML converter operable, in response to a request received over the graphical user interface, to convert the table to a file having an extensible markup language (XML) format that defines one or more dynamic groups of rows or columns corresponding respectively to the one or more ranges of measures.
